(19) United States
(12) Patent Application Publication
(10) Pub. No.: US 2012/0199094 A1
(43) Pub. Date: Aug. 9, 2012

(54) MULTI-CYLINDER IN-LINE INTERNAL COMBUSTION ENGINE FOR A MOTOR VEHICLE AND METHOD FOR OPERATING SAME

(75) Inventors: Michael Roehrig, Koln (DE); Stefan Quiring, Leverkusen (DE)

(73) Assignee: FORD GLOBAL TECHNOLOGIES, LLC, Dearborn, MI (US)

(21) Appl. No.: 13/370,153

(22) Filed: Feb. 9, 2012

(30) Foreign Application Priority Data
Feb. 9, 2011 (DE) 102011000585.4

(51) Int. Cl. F02B 75/06

(52) U.S. Cl. 123/192.2

(57) ABSTRACT

The present disclosure relates to a multi-cylinder in-line internal combustion engine for a motor vehicle, comprising a crankshaft which rotates about a crankshaft axis during operation of the internal combustion engine, a plurality of crank throws which succeed one another in an axial direction, each of which crank throws is associated with a respective cylinder in the internal combustion engine, and a compensating arrangement for at least partially compensating the inertial forces generated on the crankshaft by revolving masses. The multi-cylinder in-line internal combustion engine has a device for varying the position of at least one of the compensating masses relative to the crankshaft as a function of engine speed. The present disclosure further relates to a method for operating such a multi-cylinder in-line internal combustion engine.

### RELATED APPLICATIONS

The present application claims priority to German Patent Application No. 102011000585.4, filed on Feb. 9, 2011, the entire contents of which are hereby incorporated by reference for all purposes.

### FIELD

The present disclosure relates to a multi-cylinder in-line internal combustion engine for a motor vehicle, comprising a crankshaft rotating about a crankshaft axis during operation of the internal combustion engine and a compensating arrangement for at least partially compensating the inertial forces generated on the crankshaft by revolving masses. The present disclosure further relates to a method for operating such a multi-cylinder in-line internal combustion engine.

### BACKGROUND AND SUMMARY

In a multi-cylinder in-line internal combustion engine having, for example, three cylinders, counterweight or compensating arrangements are used in order to reduce or prevent vibrations (in particular first-order excitations) generated, the vibrations being exerted on the crankshaft by the first and third cylinders, especially in the form of an inertia couple.

DE 102 45 376 A1 describes a crankshaft for an in-line three-cylinder reciprocating piston engine in which two compensating masses forming an angle of 180° and generating equal and opposite compensating forces are provided in order to reduce the bearing loads of the crankshaft bearings, the compensation plane formed by the compensating forces including an angle of 30° with the first crank throw.

A further approach to control vibration includes accepting a high degree of vibration of the drivetrain in the vehicle longitudinal direction (that is, a high degree of so-called “yaw excitation”) in order to achieve in return small excitations of the drivetrain in the vertical direction (that is, a small degree of “pitch excitation”). Although this approach generates less vibration on the seat rail and the steering wheel because of the transmission functions in the motor vehicle, in practice problems can arise in situations or maneuvers in which high preloads are produced on the engine suspension, as is the case when making a standing start in first gear, especially on an incline or when towing a trailer, since load-dependent engine mount stiffness is greatly increased in such situations. In this case, the frequency of the rigid body modes of the drivetrain in the vehicle longitudinal direction (that is, of the “yaw excitation”) is increased from a value initially below idling speed to values in a range of typical engine speeds in driving operation (for example, up to 2500 rpm). As a result, insulation with respect to first-order excitations in the vehicle longitudinal direction is significantly reduced. At the same time, strong excitations in the main combustion order (1.5th order in the case of three-cylinder in-line engines) occur in the vehicle longitudinal direction because of the high load during combustion. As a result, the strong excitations in the first and 1.5th order lead to modulation and harsh engine noise as well as pronounced vibration on the seat rail. Accordingly, there is a desire to optimize the vibration behavior of the drivetrain with regard to driving maneuvers which produce high preloads on the engine mounts.

In one approach, an additional balancer shaft for eliminating first-order engine excitations can be used to address the above-described problem, however, this increases complexity and therefore costs, as well as friction and therefore the consumption of the internal combustion engine.

Addressing the problems described above, the present disclosure provides a multi-cylinder in-line internal combustion engine for a motor vehicle, and a method for operating same, which controls vibration behavior, especially during a standing start of the motor vehicle, with comparatively little outlay in complexity. In this way, an additional balancer shaft for eliminating first-order engine excitations may, in particular, be dispensed with, which is advantageous, inter alia, from cost considerations.

A multi-cylinder in-line internal combustion engine according to the present disclosure describes a motor vehicle that comprises a crankshaft which rotates about a crankshaft axis during operation of the internal combustion engine, a plurality of crank throws which succeed one another in an axial direction with respect to the crankshaft axis, each crank throw being associated with a respective cylinder in the internal combustion engine, and a compensating arrangement for at least partially compensating inertial forces generated on the crankshaft by revolving masses, the compensating arrangement comprising at least two compensating masses and a device for varying a position of at least one of the compensating masses relative to the crankshaft as a function of engine speed.

In this way, the present disclosure reduces vibration of the drivetrain in the vehicle longitudinal direction (that is, the “yaw excitation”) in situations and maneuvers in which high preloads are produced on the engine suspension, and accepts strong vibration of the drivetrain in the vehicle longitudinal direction in situations without such high preloads (for example, at idle). This approach starts from recognition of the fact that, in principle, a practically 100% compensation of the translational mass forces, which goes together with a high degree of vibration in the vehicle longitudinal direction concurrently with comparatively small excitations in the vertical direction, has proved favorable because of the transmission functions in the motor vehicle, and ultimately results in substantially less vibration on the seat rail and steering wheel than is the case, for example, with only 30% or 50% compensation of the translational mass forces. However, the approach also takes account of the further realization that modification of the compensation of the inertial forces generated on the crankshaft by revolving masses is desired in situations in which high preloads are produced on the engine suspension. According to the present disclosure, therefore, in order to reduce the vibration of the drivetrain in the vehicle longitudinal direction in situations in which high preloads are produced on the engine suspension (that is, for example, when making a standing start, especially on an incline or when towing a trailer), the effect of the compensation order provided for at least partially compensating the inertial forces generated on the crankshaft by revolving masses is implemented as a function of engine speed, which in turn is effected by varying the position of at least one of the compensating masses relative to the crankshaft to increase or decrease the moment of inertia in response to the operating condition.

The present disclosure is explained in more detail below with reference to exemplary embodiments which are illustrated in the figures.

### BRIEF DESCRIPTION OF THE DRAWINGS

FIG. 1 shows a schematic representation of a crankshaft for a three-cylinder internal combustion engine which is provided with a counterweight arrangement.

FIG. 2 shows a schematic side view of the arrangement of FIG. 1.

FIG. 3 shows a schematic side view illustrating the device controlling operation of the internal combustion engine of FIG. 1.

FIG. 4 shows an exemplary method of operating the internal combustion engine of FIG. 1.

### DETAILED DESCRIPTION

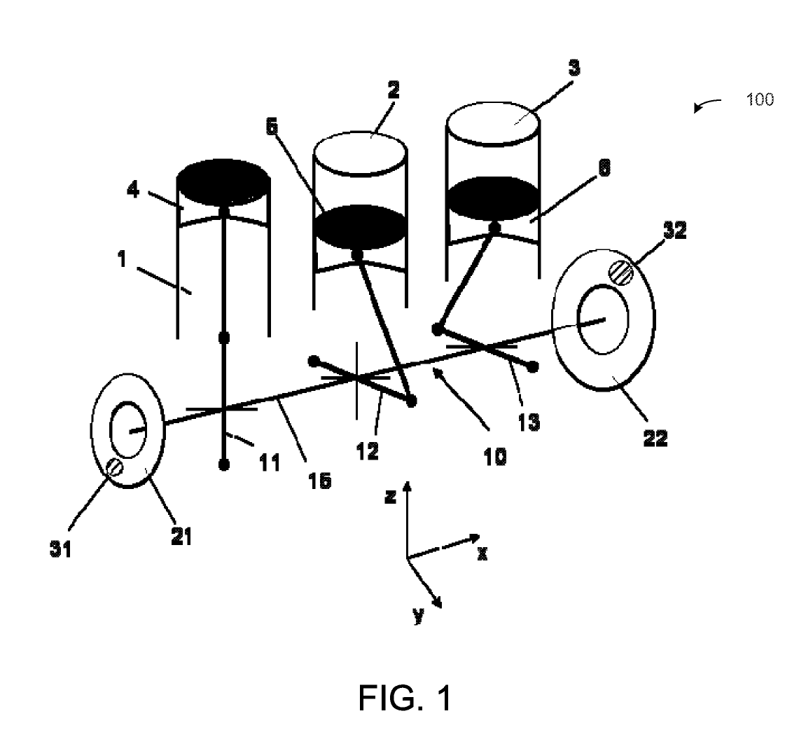

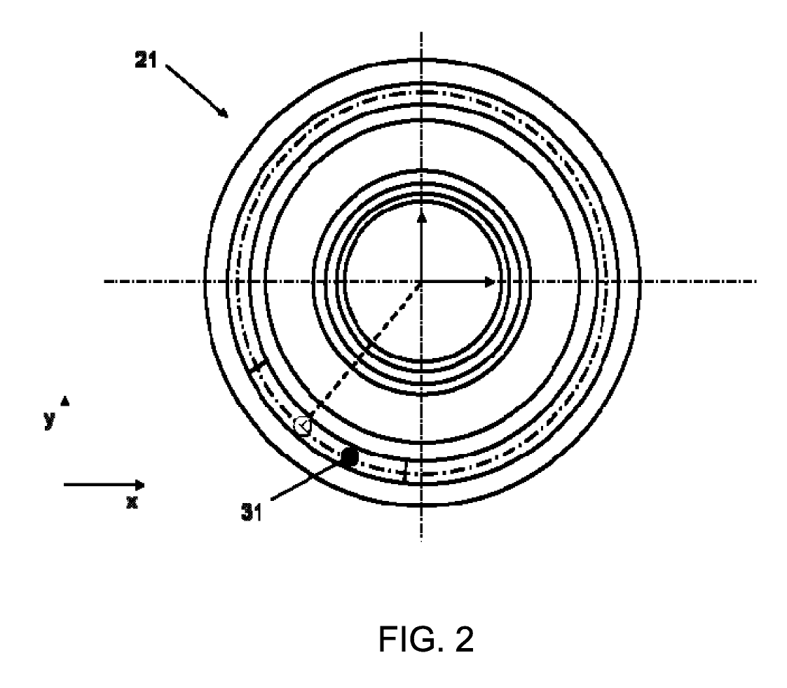

As shown in FIG. 1, a multi-cylinder internal combustion engine 100 according to the present disclosure comprising three cylinders 1, 2 and 3 and pistons 4, 5 and 6 movable therein has a crankshaft 10 which rotates during operation of the internal combustion engine 100 about a crankshaft axis 15 disposed in the x-direction in the system of coordinates indicated. Three crank throws 11, 12 and 13 succeeding one another along said crankshaft axis 15 are arranged in crankshaft 10, as represented in FIG. 1 in simplified linear form, and typically distributed around the crankshaft axis 15 with an angular spacing of 120°. The multi-cylinder internal combustion engine 100 according to the disclosure may be, in particular, a three-cylinder in-line internal combustion engine and may be included in a vehicle. A belt pulley 21 and a flywheel 22 of the internal combustion engine 100 are arranged at opposing ends of crankshaft 10; belt pulley 21 providing a driving rotational force to rotate the crankshaft 10 and flywheel 22 storing and releasing rotational energy as desired. FIG. 2 provides an alternate side-view of the crankshaft assembly of FIG. 1.

As shown in FIG. 1, a compensating arrangement comprising two compensating masses 31, 32 is further provided. This compensating arrangement serves to compensate at least partially the inertial forces generated on the crankshaft 10 by the revolving masses. Although not shown in FIG. 1, further compensating masses or counterweights in addition to the compensating masses 31, 32 may be arranged, for example, on the crank throws 11 and 13.

In the exemplary embodiment illustrated, the compensating masses 31, 32 are arranged at an angle of substantially 180° (e.g. 180°±5° to one another, that is, in a common plane disposed perpendicularly to the crankshaft axis 15.

Furthermore, the one compensating mass 31 of these compensating masses 31, 32 is arranged on the belt pulley 21 and the other compensating mass 32 on the flywheel 22. Consequently, the distance between the compensating masses 31, 32 along the crankshaft axis 15 disposed in the axial direction is greater than the maximum distance between the two outer crank throws, or the two crank throws furthest from one another in the axial direction, 11 and 13. In principle, in such a construction, the compensation of the inertial forces generated on the crankshaft 10 which is achieved by the compensating arrangement can be adjusted in such a way that it corresponds to a compensation of the translational mass forces by at least 80%. More particularly, the translational mass forces may be compensated by another value, for instance at least 90% or 100%, such that the internal combustion engine 100 may operate within a specified tolerance. According to the present disclosure, however, although such a behavior of the compensating arrangement is achieved during the idling speed of the internal combustion engine 100, its effectiveness is varied at higher engine speeds, for example, when the vehicle is making a standing start.

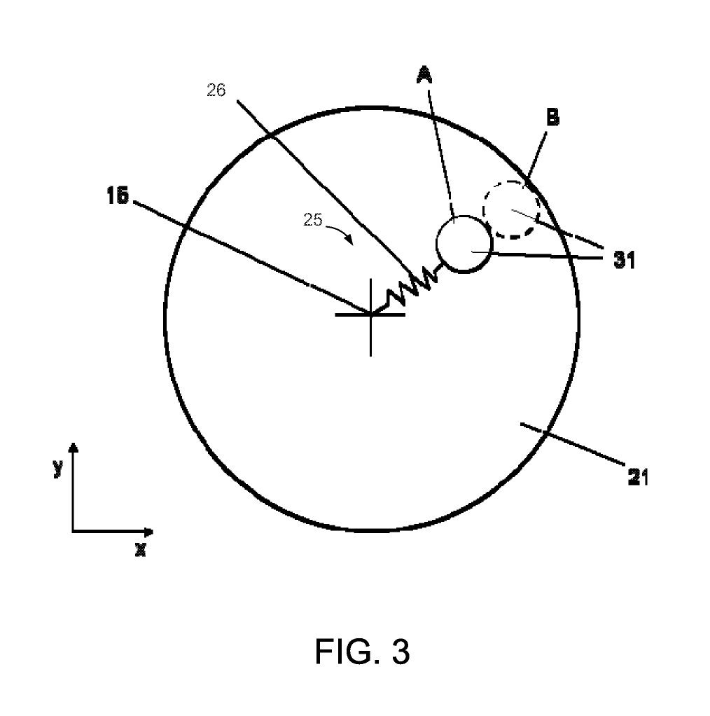

In response to this occurrence, as is indicated schematically in FIG. 3, there is provided a device 25 which varies the position of at least one compensating mass 31 relative to the crankshaft 10 as a function of engine speed. In an exemplary embodiment, the position of compensating mass 31, which is arranged on the belt pulley 21, is varied, however the position of any combination of compensating masses 31, 32 (or any additional compensating masses that may be provided) may be varied by the device 25.

The variation according to the present disclosure of the position of the compensating mass 31 relative to the crankshaft 10 is effected in the exemplary embodiment by varying the distance of this compensating mass 31 from the crankshaft 10 in a radial direction with respect to the crankshaft axis 15. The device 25 may include a spring 26, which may be attached to compensating mass 31 and may couple the compensating mass 31 to the crankshaft 10, and may be used to vary the position of the compensating mass 31. In FIG. 3 the position of the relevant compensating mass 31 is shown only schematically and qualitatively in two different situations, the position designated by A corresponding, for example, to the position at or below idling speed of the internal combustion engine 100, and the position designated by B (and shown by a broken line) corresponding to a situation with an engine speed elevated relative to the idling speed (for example, a speed of 2500 rpm).

However, compensating mass 31 may be positioned in another manner to achieve a desired performance. It is noted that moving compensating mass 31 toward crankshaft 10 (that is to say, decreasing the distance between crankshaft 10 and 31 in a radial direction with respect to crankshaft axis 15) reduces the moment of inertia of the belt pulley 21. Therefore, during operating conditions of the engine 100 that have little preload, such as during idle engine speeds, compensating mass 31 may compensate for a large amount of inertial forces in order to accept high vibration of the drivetrain in the vehicle longitudinal direction and correspondingly low vibration in the vehicle vertical direction. Alternatively, during operating conditions of the engine 100 that result in a higher engine speed, such as making a standing start, especially when on an incline or when the engine 100 is under a heavy load, compensating mass 31 may be moved away from crankshaft 10 by device 25 (the distance between crankshaft 10 and compensating mass 31 may be increased). As insulation with respect to first-order excitations in the vehicle longitudinal direction is significantly reduced during high preload conditions, this also has the added benefit of reducing the vibration of the drivetrain in the vehicle longitudinal direction in situations in which high preloads are produced on the engine suspension. In this way, the device 25 for varying the position of at least one of the compensating masses 31 may vary the distance of the at least one of the compensating masses 31 from the crankshaft 10, in a radial direction with respect to the crankshaft axis 15, as a function of engine speed.

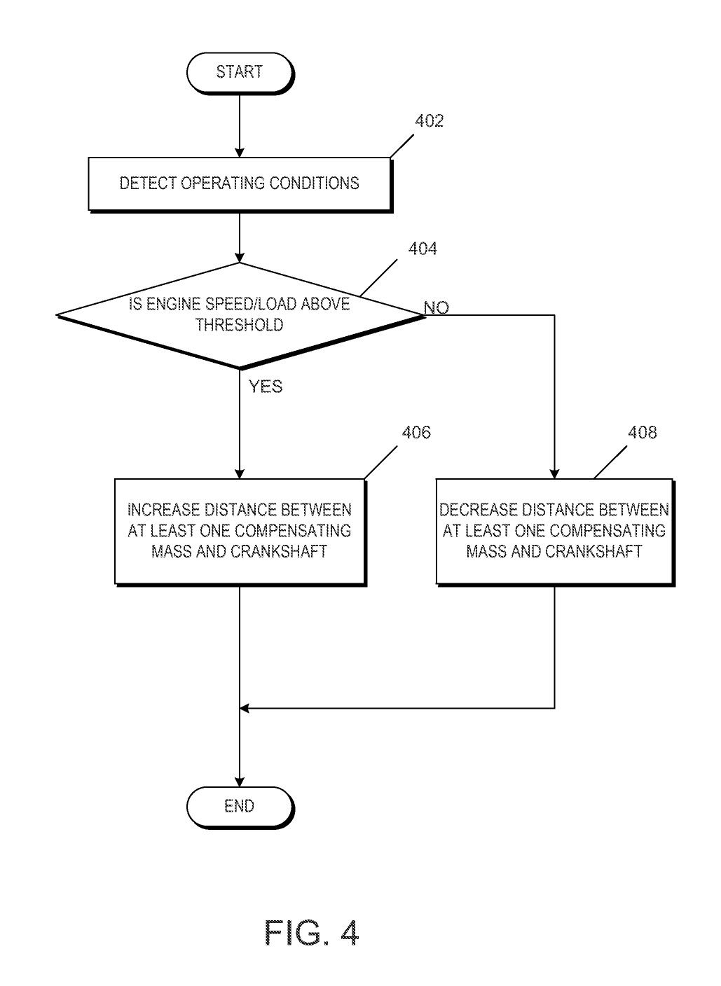

FIG. 4 shows an exemplary method of operating the internal combustion engine 100, in which distance of a compensating mass 31,32 is adjusted during engine operation responsive to engine speed. At step 402, the operating conditions of the engine 100 are detected. For instance, an engine speed or preload condition of the engine may be detected. In step 404, the detected conditions are evaluated, and it is determined whether the engine speed or load exceeds a threshold. If it is determined that the engine is operating in a first condition, in which the engine speed exceeds a threshold, for instance if it is greater than 2500 rpm, the method proceeds to step 406, in which at least one compensation mass 31 is moved to be positioned at an increased distance from the crankshaft 10. If it is determined that the engine is operating in a second condition, in which the engine speed does not exceed a threshold, for instance, during an idle condition, the method proceeds to step 408, in which the at least one compensation mass 31 is moved to be positioned at a decreased distance from the crankshaft 10. In this way, the position variation is effected at least temporarily in such a way that the distance of at least one of the compensating masses 31, 32 from the crankshaft 10, in a radial direction with respect to crankshaft axis 15, is increased with rising engine speed. This may occur in a linear manner, whereby the distance between compensation mass 31 and crankshaft 10 increases and decreases linearly with respective engine speed changes. Alternatively, positions may be pre-defined, whereby each pre-defined position corresponds to a specific engine speed or range of speeds, and compensation mass 31 is located in a pre-defined position upon the engine 100 reaching a corresponding specified speed or range of speeds.

As a result, according to the present disclosure, a compensation of the translational mass forces which is achieved by the compensating arrangement can be reduced with increasing engine speed in order to take account, for example, of situations with high preloads on the engine suspension, as occur, for example, when making a standing start in first gear.

1. An internal combustion engine for a motor vehicle, comprising:
a crankshaft which rotates about a crankshaft axis during operation of the internal combustion engine;
a plurality of crank throws which succeed one another in an axial direction with respect to the crankshaft axis, each crank throw being associated with a respective cylinder in the internal combustion engine; and
a compensating arrangement for at least partially compensating inertial forces generated on the crankshaft by revolving masses, the compensating arrangement comprising at least two compensating masses and a device for varying a position of at least one of the compensating masses relative to the crankshaft as a function of engine speed.

2. The internal combustion engine as claimed in claim 1, wherein the device for varying the position of at least one of the compensating masses varies the distance of at least one of the compensating masses from the crankshaft in a radial direction with respect to the crankshaft axis as a function of engine speed.

3. The internal combustion engine of claim 1, wherein the device for varying the position of at least one of the compensating masses varies the position of a compensating mass arranged on a belt pulley relative to the crankshaft as a function of engine speed.

4. The internal combustion engine of claim 1, wherein the device for varying the position of at least one of the compensating masses includes a spring.

5. The internal combustion engine of claim 1, wherein the internal combustion engine is a three-cylinder in-line internal combustion engine.

6. A method for operating an internal combustion engine in a motor vehicle comprising:
driving, with a belt pulley, a crankshaft of the internal combustion engine to rotate about a crankshaft axis during operation of the internal combustion engine, the crankshaft including a plurality of crank throws which succeed one another in an axial direction with respect to the crankshaft axis, each crank throw being associated with a respective cylinder in the internal combustion engine; and
compensating, at least partially, inertial forces generated on the crankshaft by revolving masses with a compensating arrangement comprising at least two compensating masses, a position of at least one of the compensating masses being varied as a function of engine speed.

7. The method of claim 6, wherein the varying of the position of at least one of the compensating masses is effected at least temporarily in that the distance of at least one of the compensating masses from the crankshaft in a radial direction with respect to the crankshaft axis is increased with rising engine speed.

8. The method of claim 6, wherein the varying of the position of at least one of the compensating masses is effected at least temporarily in that a compensation of the translational mass forces achieved by the compensating arrangement is reduced with rising engine speed.

9. The method of claim 6, wherein at idling speed the compensating masses are arranged in such a manner that a compensation achieved by the compensating arrangement of the inertial forces generated on the crankshaft corresponds to a compensation of the translational mass forces by at least 90%.

10. The method of claim 6, wherein the at least one compensating mass is positioned on the belt pulley.

11. An engine method, comprising:
during a first condition, increasing a distance between a compensating mass and an engine crankshaft; and
during a second condition, decreasing the distance.

12. The method of claim 11, wherein the first condition is a higher engine speed than the second condition.

13. The method of claim 12, wherein the distance is adjusted during engine operation responsive to engine speed.

14. The method of claim 13, wherein the first condition is an engine speed above idle, and the second condition is an engine speed at or below idle.

15. The method of claim 14, wherein the distance is adjusted by a device including a spring that is attached to the compensating mass.

16. The method of claim 11, wherein the compensating mass is positioned on a belt pulley attached to the engine crankshaft.

17. The method of claim 16, wherein a second compensating mass is positioned on a flywheel attached to the engine crankshaft opposite to the belt pulley.

18. The method of claim 11 wherein the first condition includes a higher engine load than the second condition.

19. The method of claim 11, wherein during the first condition, the compensating mass is positioned such that a compensation achieved by the compensating arrangement of the inertial forces generated on the crankshaft corresponds to a lower compensation of the translational mass forces than achieved during the second operating condition.

20. The method of claim 11, wherein a device including a spring varies the distance between the compensating mass and the crankshaft.
